(19) United States
(12) Patent Application Publication
(10) Pub. No.: US 2010/0319149 A1
(43) Pub. Date: Dec. 23, 2010

(54) INFANT TOOTHBRUSH

(75) Inventor: Heather Phillips, West Jordan, UT (US)

Correspondence Address: TRASKBRITT, P.C., P.O. BOX 2550, SALT LAKE CITY, UT, 84110, US

(73) Assignee: LIVE-RIGHT, LLC, Pocatello, ID (US)

(21) Appl. No.: 12/666,262

(22) PCT Filed: Apr. 9, 2008
(86) PCT No.: PCT/US08/59748

§ 371 Date: Dec. 22, 2009

Related U.S. Application Data
(60) Provisional application No. 60/946,329, filed on Jun. 26, 2007.

(51) Int. Cl. A46B 15/00; A46B 9/04; A61J 17/00

(52) U.S. Cl. 15/105; 15/167.1; 606/235

(57) ABSTRACT

A toothbrush for infants includes an elongate grasping region with a head at one end and a bottom at the other end. The head of the toothbrush includes a plurality of bristles, which may be formed from a soft, resiliently compressible material. The elongate grasping region may have dimensions that enable it to be held by an infant's hand while preventing its insertion and, thus, over-insertion of the toothbrush, into the infant's mouth. Various other features may be included to guide an infant's hand to an appropriate location on the toothbrush, as well as to enable an infant to grip the grasping region, particularly when moisture is present on the surface of the grasping region.

### PRIORITY CLAIM

This application claims the benefit of the filing date of U.S. Provisional Patent Application Ser. No. 60/949,329, filed Jun. 26, 2007, for “INFANT TOOTHBRUSH.”

### TECHNICAL FIELD

The present invention relates generally to teething apparatus and toothbrushes for infants and, more specifically, to teething apparatus and toothbrushes that are configured to maximize an infant's oral comfort while promote healthy habits and minimizing risk of injury.

### BACKGROUND

Infant toothbrushes are often configured similarly to conventional teething rings. More specifically, existing infant toothbrushes, such as that described in U.S. Pat. No. 5,048,143, include a large, ring-shaped handle with bristles protruding therefrom. As a consequence of such a configuration, the bristles cannot be inserted into the mouth of an infant in a manner similar to the use of a conventional toothbrush. Moreover, since the handle of such a toothbrush is configured like a teething ring, it, and any germs on its surface, may be easily inserted into the infant's mouth.

The inventor is not aware of an infant toothbrush that is configured for use like a conventional toothbrush, with features that optimize safety and comfort for infant use.

### DISCLOSURE OF THE INVENTION

The present invention includes an apparatus that includes soft bristles for brushing an infant's gums and/or teeth. Accordingly, an apparatus that incorporates teachings of the present invention is referred to herein as a “toothbrush.” The toothbrush may be configured and, optionally, include features that also facilitate its use as a teething apparatus, or toy.

In one embodiment, such a toothbrush may be an elongate element that includes an elongate grasping region with a head at one end and a bottom at the other end. The head of the toothbrush includes a plurality of bristles, which may be formed from a soft, resiliently compressible material. The elongate grasping region may have dimensions that enable it to be held by an infant's hand while preventing its insertion and, thus, over-insertion of the toothbrush, into the infant's mouth. Various other features may be included to guide an infant's hand to an appropriate location on the toothbrush, as well as to enable an infant to grip the grasping region, particularly when moisture is present on the surface of the grasping region.

A toothbrush that incorporates teachings of the present invention may be somewhat curved, such as with a generally crescent shape. The curvature of the toothbrush, as well as other features thereof (e.g., the size and/or shape of a head of the toothbrush, a size and/or shape of a bottom of the toothbrush, etc.), may be configured to facilitate introduction of the head and/or bottom of the toothbrush into otherwise difficult-to-reach areas of an infant's mouth (e.g., posterior regions, etc.).

According to another aspect, the present invention includes methods for teaching or training children proper oral hygiene techniques. Such methods may include use of a toothbrush with bristles that will not damage or irritate an infant's sensitive gums with prolonged use, use of a toothbrush having guiding features that facilitate placement of an infant's hand to an appropriate location on the toothbrush, and use of a toothbrush with features that enable an infant to maintain a firm grasp even in the presence of moisture. In use, a toothbrush is placed in an infant's hand, the head of the toothbrush is introduced into the infant's mouth, and the toothbrush is move moved in a rubbing or brushing motion.

Other features and advantages of the present invention will become apparent to those of ordinary skill in the art through consideration of the ensuing description, the accompanying drawings, and the appended claims.

### DESCRIPTION OF THE DRAWINGS

In the drawings, which depict various features of an embodiment of and infant toothbrush of the present invention:

FIG. 1 is a perspective view of the infant toothbrush;

FIG. 2 shows one side of the infant toothbrush;

FIG. 3 depicts the other side of the infant toothbrush;

FIG. 4 is a top view of the infant toothbrush;

FIG. 5 is a bottom view of the infant toothbrush;

FIG. 6 illustrates the infant toothbrush from an end of its head;

FIG. 7 depicts the infant toothbrush from its bottom end;

FIG. 8 shows a cross-section taken through a central location of the toothbrush, transverse to its length; and

FIG. 9 is an exploded perspective view of the toothbrush.

### MODE(S) FOR CARRYING OUT THE INVENTION

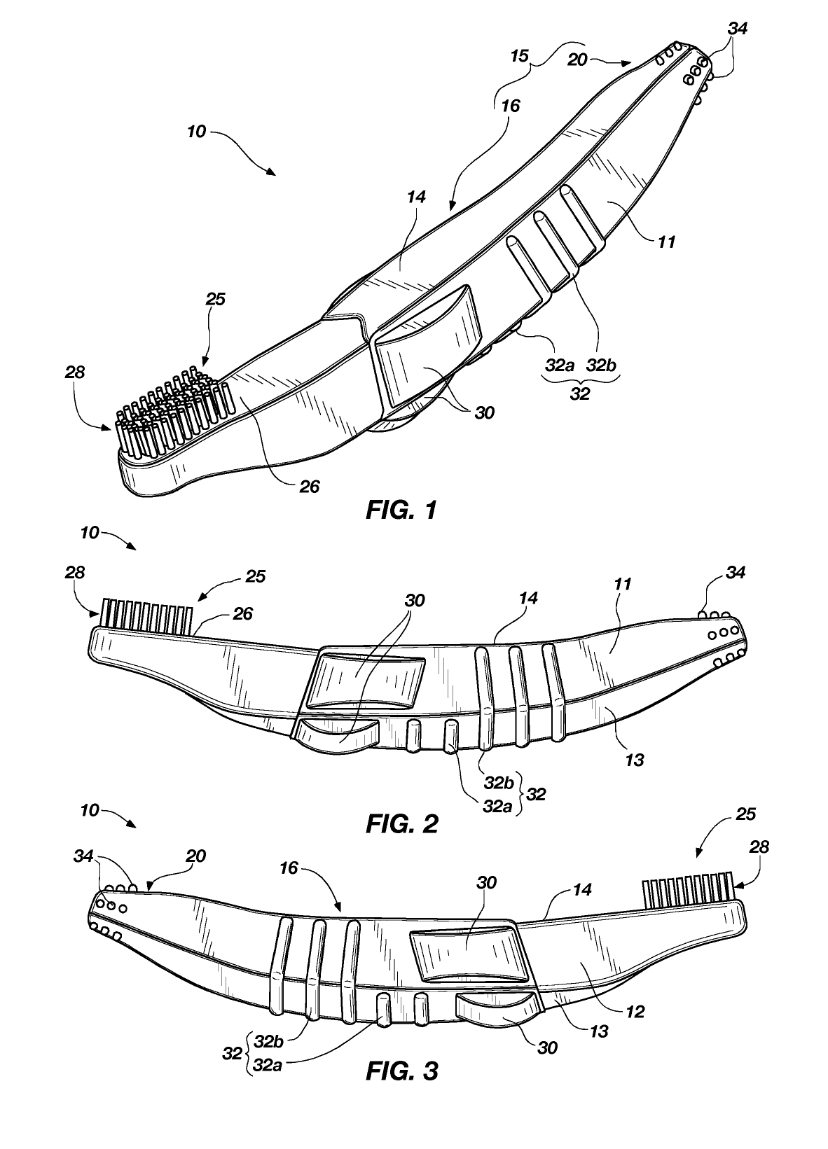

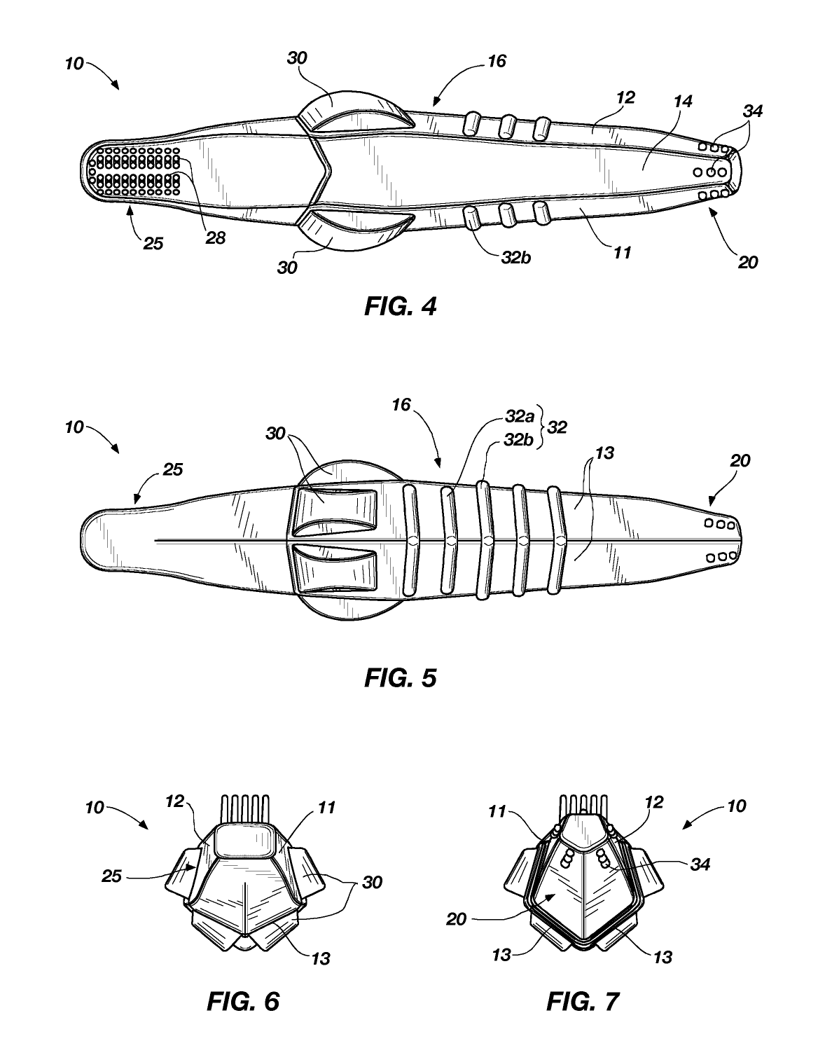

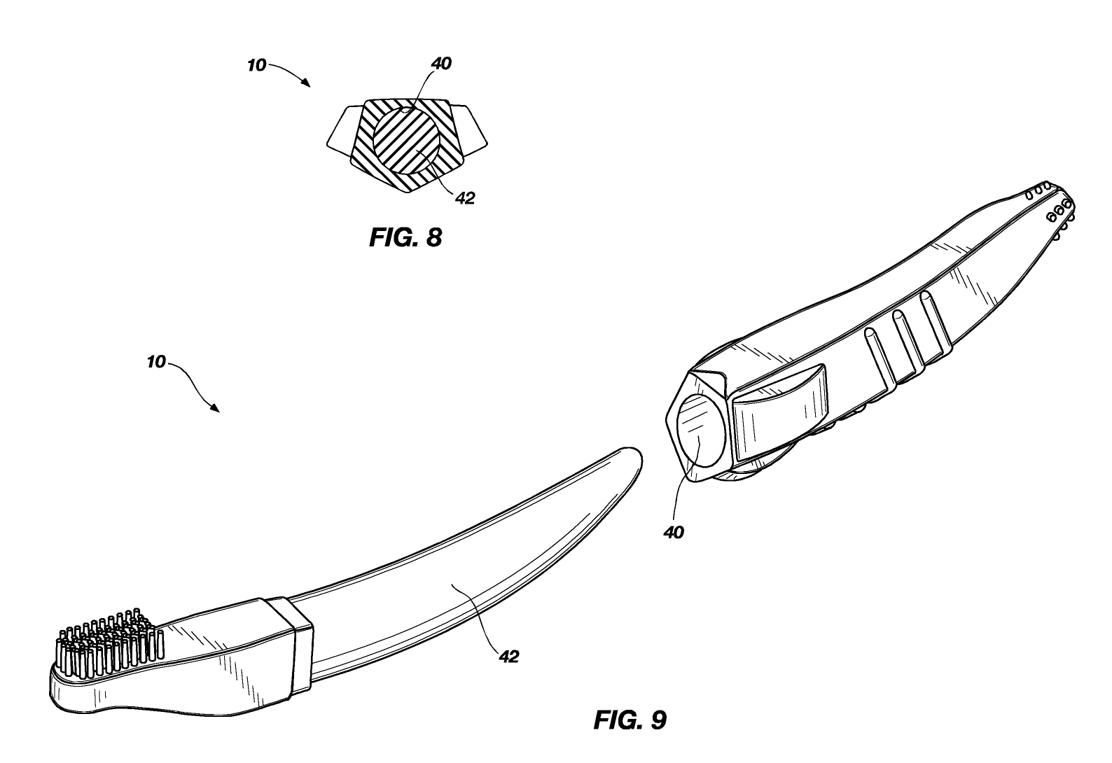

An embodiment of a toothbrush 10 that incorporates teachings of the present invention is shown in FIGS. 1 through 7. Toothbrush 10 includes an elongate handle 15 with a central, grasping region 16 and a bottom 20 at one end 18 of grasping region 16. A head 25 is located adjacent to the other end 19 of grasping region 16 (i.e., opposite from bottom 20).

As depicted, toothbrush 10 may have a somewhat curved shape, such as a crescent shape or the general appearance of a banana, as depicted in FIGS. 1 through 7. Such a shape facilitates insertion of toothbrush 10 into areas of an infant's mouth into which other infant toothbrushes or teething apparatus may not be easily introduced, including posterior regions. As a result, the overall shape of toothbrush 10 may be configured to facilitate massaging of gums, reduction in pain, and/or reduction of cavity-causing bacteria from otherwise difficult to reach regions of an infant's mouth.

Of course, toothbrushes of other shapes or configurations are also within the scope of the present invention.

The cross-sectional dimensions of grasping region 16, taken transverse to its length (and, thus, to the length of handle 15), are, when considered in connection with the length of toothbrush 10, configured to minimize any choking hazards presented by toothbrush 10. Additionally, the cross-sectional dimensions of grasping region 16 enable infants to firmly grasp and manipulate (e.g., use) toothbrush 10.

As FIGS. 1 through 3 illustrate, a face 26 of head 25 is substantially flat. A group of bristles 28 protrudes from face 26. Bristles 28 may be arranged in any suitable manner known in the art for brushing teeth, with the substantially parallel bristles that are shown merely comprising a non-limiting example of a bristle arrangement. The length of head 25, as well as its cross-sectional dimensions, taken transverse to its length, may facilitate insertion of head 25 and, thus, of bristles 28 into an infant's mouth. Of course, these dimensions may also be configured to prevent gagging by the infant.

Gagging may be further prevented by the presence of one or more stoppers 30 between head 25 and handle 15 of toothbrush 10. In the illustrated example, toothbrush 10 includes three stoppers 30, two of which are positioned on opposite sides 11 and 12 of toothbrush 10, with a third protruding from a back 13 of toothbrush 10. Stoppers 30 may be configured to provide a region of enlarged cross-sectional dimensions along the length of toothbrush 10 to limit the distance that toothbrush 10 may be inserted into an infant's mouth. Stoppers 30 of the illustrated embodiment enhance the overall appearance of toothbrush 10, having the look of portions of a banana peel that have been pulled away from an end of the banana.

Stoppers 30 may also have dimensions and a shape that guide an infant's hand to an appropriate location along the length of grasping region 16 of handle 15, which may be useful in training the infant to hold and manipulate a toothbrush. Due to their positioning adjacent to grasping region 16, stoppers 30 may prevent slippage of the infant's hands as he or she is using toothbrush 10.

An infant's gripping of toothbrush 10 may also, or alternatively, be facilitated by grip-enhancing features associated with grasping region 16. As a non-limiting example of grip-enhancing features, grasping region 16 may include raised ridges, or grips 32, that enable an infant to firmly grasp toothbrush 10 regardless of the material from which grasping region 16 is formed, or the presence of moisture (e.g., water, saliva, etc.) on grasping region 16. As shown, grips 32 are elongate elements that are oriented transverse to the length of and protrude slightly from grasping region 16, with some grips 32a extending across only the width of back 13 of toothbrush 10 and other grips 32b extending across the width of back 13 and down sides 11 and 12 of toothbrush 10. Of course, a wide variety of other grip-enhancing features and arrangements of such features are also within the scope of the present invention.

Bottom 20 of handle 15 may have smaller cross-sectional dimensions, taken transverse to the length of handle 15, than the corresponding cross-sectional dimensions of grasping region 20, similar to the relative dimensions of head 25 and grasping region 20. The dimensions of bottom 20 may facilitate its insertion into a teething infant's mouth.

Teething features, such as the depicted nubs 34 or the like (e.g. ridges, indentations, etc.), may be present on bottom 20. In the pictured embodiment, nubs 34 are arranged in rows of three that extend along the length of bottom 20, with one row on each of sides 11 and 12, back 13, and face 14 of toothbrush 10.

The shape of toothbrush 10, including the central position of grasping region 16 between regions (i.e., bottom 20 and head 25) that are configured to be inserted into an infant's mouth, as well as the larger size of grasping region 16 and the location of stoppers 30, may prevent the surfaces of toothbrush 10 that are most likely to be handled by the infant from being introduced into the infant's mouth. Thus, toothbrush 10 may have a shape that reduces the likelihood that germs will introduced into the infant's mouth.

Toothbrush 10 and, optionally, features thereof (e.g., bristles 28, stoppers 30, grips 32, and nubs 34) may be formed from a soft, compressible, resilient material, which minimizes irritation to the infant's gums and teeth, and is less susceptible to causing damage within an infant's mouth in the event that toothbrush 10 is forcefully inserted into the infant's mouth (e.g., as the result of a fall, over-exuberant movement by the infant, etc.). For example, and not by way of limitation, hypoallergenic silicone may be used to form toothbrush 10. The material from which toothbrush 10 is formed may have a color that corresponds to its configuration (e.g., one or more shades of yellow when toothbrush 10 is configured as a banana), that may attract an infant's interest, or for any other purpose. Additionally, the material of toothbrush 10 may include fragrance or flavoring (e.g., a banana scent or flavor, etc.).

In the depicted embodiment, all of the external features of toothbrush 10 are formed from the same material, with separately molded features (e.g., head 25 and handle 15) having been assembled and glued or cemented to one another (e.g., with a room temperature vulcanizing (RTV) silicone, etc.). Alternatively, some features of toothbrush 10 may be formed from different materials. For example, head 25 may include bristles 28 that are formed from conventional materials (e.g., synthetic fibers, such as the polyamide fibers marketed by duPont de Nemours & Co. of Wilmington, Del., under the trade mark NYLON®) that protrude from a suitable carrier (e.g., a plastic base).

Referring now to FIGS. 8 and 9, toothbrush 10 may include an interior cavity 40 within which an insert 42 is positioned (e.g., during assembly of separately molded parts). Insert 42 may impart toothbrush 10 with more rigidity and support than that provided by the material or materials used to form the reminder of toothbrush 10. In the example where silicone is used to form the majority of toothbrush 10, a harder, more rigid polymer with some flexibility (e.g., a suitable thermoplastic elastomer (TPE), etc.).

Toothbrush 10 may be used in any of a variety of ways. Toothbrush 10, as well as any bristles 28 and nubs 34 thereof, are particularly useful for massaging and easing pain in an infant's gums. Toothbrush 10 may be cooled or coated with an anesthetic agent prior to use to provide further pain relief. Due to its suitability for use with infants, for example, because of its dimensions and the materials from which it is formed, toothbrush 10 may be more suitable for use in training infants to brush their teeth (e.g., less irritating to an infant's gums and teeth) than conventionally configured toothbrushes. By using toothbrush 10, an infant may be exposed to and, thus, learn oral brushing motions and techniques and, thus, oral hygiene, at an early age.

Although the foregoing description includes many specifics, these should not be construed as limiting the scope of the present invention but, merely, as providing illustrations of some of the presently preferred embodiments. Similarly, other embodiments of the invention may be devised which do not depart from the spirit or scope of the present invention. Features from different embodiments may be employed in combination. The scope of the invention is, therefore, indicated and limited only by the appended claims and their legal equivalents, rather than by the foregoing description. All additions, deletions and modifications to the invention as disclosed herein which fall within the meaning and scope of the claims are to be embraced thereby.

What is claimed:

1. A toothbrush, comprising:
an elongate grasping region having dimensions that enable the elongate grasping region to be held by an infant's hand while preventing insertion of the elongate grasping region into the infant's mouth;
a head at an end the elongate grasping region, the head including a plurality of bristles comprising a soft, compressible, resilient material; and
a bottom at another end of the elongate grasping region.

2. The toothbrush of claim 1, wherein the plurality of bristles comprise silicone.

3. The toothbrush of claim 2, wherein the elongate grasping region, the head, and the bottom comprise silicone.

4. The toothbrush of claim 1, further comprising:
at least one stopper protruding from at least one surface proximate to a boundary between the elongate grasping region and the head.

5. The toothbrush of claim 4, wherein the at least one stopper is configured to facilitate positioning of the infant's hand at an appropriate location on the elongate grasping region for tooth brushing.

6. The toothbrush of claim 4, wherein the at least one stopper is configured to prevent over-insertion of the head into the infant's mouth.

7. The toothbrush of claim 1, wherein the bottom includes at least one teething feature.

8. The toothbrush of claim 1, wherein the elongate grasping region includes means for gripping.

9. The toothbrush of claim 1, further comprising:
an elongate insert extending internally through the elongate grasping region and into the head, the elongate insert comprising a flexible member that is more rigid than the material of the head.

10. The toothbrush of claim 1, wherein the soft, resilient, compressible member is selected or formulated to minimize damage within an infant's mouth and to maximize comfort when introduced into the infant's mouth.

11. The toothbrush of claim 1, having the appearance of a banana.

12. The toothbrush of claim 1, comprising a material including at least one of a fragrance and a flavor.

13. A toothbrush, comprising:
a handle comprising a crescent shape;
a head at an end of the handle and having at least one smaller cross-sectional dimension than a corresponding cross-sectional dimension of at least a central region of the handle, a shape and size of the head and the crescent shape of the handle together being configured to enable the head to be introduced into a posterior region of a mouth of an infant; and
bristles protruding from the head.

14. A method for teaching an infant proper oral hygiene, comprising:
guiding the infant's hand to an appropriate position along an elongate infant toothbrush, at least one stopper protruding from a length of the elongate infant toothbrush facilitating proper positioning of the infant's hand;
introducing a head of the toothbrush into the infant's mouth into a hand of the infant, the at least one stopper preventing the head from being inserted too far into the infant's mouth; and
rubbing soft, resiliently compressible bristles protruding from the head against gums or teeth in the infant's mouth.
